(19) United States
(12) Patent Application Publication
(10) Pub. No.: US 2024/0430662 A1
(43) Pub. Date: Dec. 26, 2024

(54) SPLIT LNA WITH DIFFERENT GAINS FOR MULTIPLE SUBSCRIBER IDENTITY MODULE (SIM) OPERATION

(71) Applicant: QUALCOMM Incorporated, San Diego, CA (US)

(72) Inventors: Jang Joon Lee, San Diego, CA (US); Aleksandar Miodrag Tasic, San Diego, CA (US); Kyle David Holland, San Diego, CA (US); Chih-Fan Liao, San Diego, CA (US); Prakash Thoppay Egambaram, San Diego, CA (US); Jian Kang, San Diego, CA (US); Bo Wen, San Diego, CA (US)

(21) Appl. No.: 18/338,303

(22) Filed: Jun. 20, 2023

(51) Int. Cl. H04W 8/18; H04B 1/00

(52) U.S. Cl. CPC H04W 8/183; H04B 1/005

(57) ABSTRACT

This disclosure provides systems, methods, and devices for wireless communications that support multiple subscriber identity module (MSIM) operation. In a first aspect, an apparatus for wireless communications includes an input port for receiving a radio frequency (RF) signal comprising a first carrier corresponding to a first subscriber identity module (SIM) and a second carrier corresponding to a second subscriber identity module (SIM); and a split low noise amplifier (LNA) coupled to the input port and a first output port and a second output port, the split LNA configured to output the RF signal with a first gain as a first amplified RF signal at the first output port and to output the RF signal with a different, second gain as a second amplified RF signal at the second output port. Other aspects and features are also claimed and described.

### TECHNICAL FIELD

Aspects of the present disclosure relate generally to wireless communication systems, and more particularly, to radio frequency (RF) processing circuitry for wireless communication systems. Some features may enable and provide improved communications, including improved operation of RF transceivers for multiple subscriber identity module (SIM) operation.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Modern wireless communication networks are sophisticated networks that involve operation on multiple frequencies and multiple frequency ranges. RF signals in different frequencies and ranges may use different components or different configurations of components to support a device operating on these wireless communication networks and maintain high signal integrity and high bandwidth across a range of possible network conditions. The duplication of components and number of supported configurations presents challenges in designing RF systems for the UEs and BSs operating on wireless communication networks.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A UE, such as a mobile phone device, may include a plurality of subscriber identity modules (SIMs). For example, when all SIMs in a multi-SIM UE are active, the UE may be a multi-SIM-multi-active (MSMA) UE. When one SIM in a multi-SIM UE is active while the rest of the SIM(s) is standing by, the UE may be a multi-SIM-multi-standby (MSMS) UE. Each SIM may be provided a subscription to a RAT, such as, but not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), 5G, and the like), Global System for Mobile Communications (GSM), General Packet Radio Service (GPRS), Wi-Fi, Personal Communications Service (PCS), or other protocols that may be used in a wireless communications network or a data communications network.

In multiple SIM (MSIM) operation, the UE may receive multiple signals on multiple carriers from multiple base stations. Each of the signals may arrive with a different signal power level. In some environments, the difference in signal power level between a first carrier signal received from a first base station and a second carrier signal received from a second base station could be as much, or more than 40 dB. Conventionally, different LNAs are included in a radio frequency front end (RFFE) for providing different amplification levels to the different carrier signals to process the carrier signals by using different gain states. Multiple conductors are then used to carry the differently-amplified signals from the RFFE to a RF transceiver for further processing to obtain baseband signals and extract data from the baseband signals.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

In some aspects of this disclosure, amplification gains on different outputs of a split LNA of a RF transceiver may be differently controlled to support MSIM operation. The gain control in the split LNA may be achieved using, for example, slice control, bias control, and attenuator control of a split LNA in the RF transceiver and/or through gain of separate baseband filters (BBFs) coupled to the outputs of the split LNA. Applying different gains in the transceiver using a split LNA in the RF transceiver reduces the need for separate LNAs external to the RF transceiver, such as in the RFFE. Additionally, the number of conductors between the RFFE and the RF transceiver may be reduced, which reduces the form factor of a mobile device and reduces possible interference as RF signals are transported across conductors to the RF transceiver in a mobile device.

A UE according to different embodiments of this disclosure may support different variants of MSIM operation. A UE provided with a plurality of SIMs and supporting idle mode waiting to begin communications on two or more separate (or same) RATs through the plurality of SIMs is a multi-SIM-multi-standby (MSMS) communication device. In some MSMS devices, one or more components of transmission hardware (e.g., radio-frequency (RF) transceivers) are shared for operation with the plurality of SIMs. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a UE that includes a plurality of SIMs and connects to two or more separate (or same) RATs and supports active communication using the plurality of SIMs is termed a multi-SIM-multi-active (MSMA) communication device. The MSMA device may use two or more sets of transmission hardware (with some hardware shared and/or specific to each of the sets or all hardware dedicated to one set). An example MSMA communication device is a dual-SIM-dual-active (DSDA) communication device, which includes two SIM cards/subscriptions. Both SIMs may remain active. In another example, the MSMA device may be a triple-SIM-triple-active (TSTA) communication device, which includes three SIM cards/subscriptions. All three SIMs may remain active. In other examples, the MSMA communication device may be other suitable multi-SIM communication devices with four or more SIMs, for which that all SIMs may be active.

Embodiments described herein relate to a multi-SIM context, such as, but not limited to, the MSMS and MSMA contexts. For example, in the multi-SIM context, each subscription may be configured to acquire service from a base station (associated with a given cell).

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein relate to both MSMA and MSMS UEs, where two or more of the subscriptions would locate and link to a same serving cell after respective service acquisition processes. Systems and processes described in embodiments herein refer to two subscriptions. However, a UE with three or more subscriptions may implement systems and methods described in similar manners. Both subscriptions may be associated with a same RAT. In a non-limiting example, systems and methods may be implemented with a MSMS or MSMA UE having a first subscription and a second subscription, each of which may be associated with WCDMA. Both subscriptions may be associated with a same public land mobile network (PLMN). Accordingly, both subscriptions may find a same cell when both subscriptions are associated with a same PLMN. The PLMN may be a function of a mobile country code (MCC) and mobile network code (MNC), as stored on a SIM.

In one aspect of the disclosure, an apparatus for wireless communications may include an input port for receiving a radio frequency (RF) signal comprising a first carrier corresponding to a first subscriber identity module (SIM) and a second carrier corresponding to a second subscriber identity module (SIM); a split low noise amplifier (LNA) coupled to the input port and a first output port and a second output port, the split LNA configured to output the RF signal with a first gain as a first amplified RF signal at the first output port and to output the RF signal with a different, second gain as a second amplified RF signal at the second output port; a first RF processing chain coupled to the first output port for processing the first carrier; and a second RF processing chain coupled to the second output port for processing the second carrier.

In another aspect of the disclosure, a method for wireless communication includes determining a multiple subscriber identity module (MSIM) operating configuration for processing a first carrier signal and a second carrier signal of an RF signal; determining a first amplifier gain for the first carrier signal of the MSIM operating configuration; determining a different, second amplifier gain for the second carrier signal of the MSIM operating configuration; and configuring a RF transceiver comprising a split LNA with a first output and a second output with the first amplifier gain for the first output and the second amplifier gain for the second output.

In an additional aspect of the disclosure, an apparatus includes at least one processor and a memory coupled to the at least one processor. The at least one processor is configured to perform operations including determining a multiple subscriber identity module (MSIM) operating configuration for processing a first carrier signal and a second carrier signal of an RF signal; determining a first amplifier gain for the first carrier signal of the MSIM operating configuration; determining a different, second amplifier gain for the second carrier signal of the MSIM operating configuration; and configuring a RF transceiver comprising a split LNA with a first output and a second output with the first amplifier gain for the first output and the second amplifier gain for the second output.

In an additional aspect of the disclosure, an apparatus includes means for determining a multiple subscriber identity module (MSIM) operating configuration for processing a first carrier signal and a second carrier signal of an RF signal; means for determining a first amplifier gain for the first carrier signal of the MSIM operating configuration; means for determining a different, second amplifier gain for the second carrier signal of the MSIM operating configuration; and means for configuring a RF transceiver comprising a split LNA with a first output and a second output with the first amplifier gain for the first output and the second amplifier gain for the second output.

In an additional aspect of the disclosure, a non-transitory computer-readable medium stores instructions that, when executed by a processor, cause the processor to perform operations. The operations include determining a multiple subscriber identity module (MSIM) operating configuration for processing a first carrier signal and a second carrier signal of an RF signal; determining a first amplifier gain for the first carrier signal of the MSIM operating configuration; determining a different, second amplifier gain for the second carrier signal of the MSIM operating configuration; and configuring a RF transceiver comprising a split LNA with a first output and a second output with the first amplifier gain for the first output and the second amplifier gain for the second output.

In a further aspect of the disclosure, an apparatus for wireless communications includes a radio frequency front end (RFFE) comprising an antenna input port for receiving a radio frequency (RF) signal comprising a first carrier signal and a second carrier signal, an output port for outputting a processed RF signal based on the RF signal, and a low noise amplifier (LNA) coupled between the antenna input port and the output port; and a radio frequency (RF) transceiver comprising an RF input port for receiving the processed RF signal from the RFFE, a split LNA coupled to the RF input port and a first output port and a second output port, the split LNA configured to output the processed RF signal with a first gain as a first amplified RF signal at the first output port and to output the RF signal with a different, second gain as a second amplified RF signal at the second output port, a first RF processing chain coupled to the first output port for processing the first carrier signal to output a first baseband signal, a second RF processing chain coupled to the second output port for processing the second carrier signal to output a second baseband signal, and a baseband processor coupled to the first RF processing chain and the second RF processing chain and configured to process the first baseband signal based on first information from a first subscriber identity module (SIM) and process the second baseband signal based on second information from a second subscriber identity module (SIM).

As used herein, a “radio frequency” signal is a signal having a frequency above baseband, which includes, in an example embodiment of a heterodyne receiver, intermediate frequency signals.

As used herein, an “intermediate frequency” signal is a RF signal that has been downconverted from another RF signal to a frequency that is above baseband, such as in an example embodiment of a heterodyne mmWave transceiver that receives a mmWave RF signal and downconverts the mmWave RF signal to a mmWave IF signal that is further processed, such as through further downconversion, to a lower frequency RF signal or a baseband signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects of the disclosure.

FIG. 2 is a block diagram illustrating examples of a base station and a user equipment (UE) according to one or more aspects of the disclosure.

FIG. 3 is a block diagram illustrating a frequency (RF) transceiver according to one or more aspects of the disclosure.

FIG. 4 is a block diagram illustrating multiple-SIM operation according to one or more aspects of the disclosure.

FIG. 5A is a block diagram illustrating an RF processing circuit with a split LNA for MSIM operation according to one or more aspects of the disclosure.

FIG. 5B is a block diagram illustrating an RF processing circuit with a split LNA for CA operation according to one or more aspects of the disclosure.

FIG. 6A is a split LNA circuit with adjustable output gains based on slices, bias, feedback resistance according to one or more aspects of the disclosure.

FIG. 6B is a split LNA circuit with adjustable output gains based on multiple amplification stages according to one or more aspects of the disclosure.

FIG. 6C is a split LNA circuit with individual attenuators for each LNA to provide gain control according to one or more aspects of the disclosure.

FIG. 7 is a flow chart illustrating an example transceiver operation for MSIM and CA operation according to one or more aspects of the disclosure.

FIG. 8 is a block diagram of an example UE that supports RF transceivers with MSIM operation in a wireless radio according to one or more aspects of the disclosure.

FIG. 9 is a block diagram of an example base station that supports RF transceivers with MSIM operation in a wireless radio according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support RF signal processing, including techniques for adjusting gains in an RF transceiver according to a mode of operation being either carrier aggregation (CA) or multiple-SIM (MSIM). The gain control may be achieved using, for example, slice control, bias control, and/or attenuator control of a split LNA in the RF transceiver and/or through gain of separate baseband filters (BBFs) coupled to the outputs of the split LNA. The gain control may provide different amplification gains within the RF transceiver to different carrier signals during MSIM operation.

Particular implementations of the subject matter described in this disclosure may be implemented to realize one or more of the following potential advantages or benefits. In some aspects, the present disclosure provides techniques for applying separate gains in the transceiver using a split LNA in the RF transceiver to reduce the number of and need for separate LNAs external to the RF transceiver, such as in the RFFE. Additionally, the number of conductors between the RFFE and the RF transceiver may be reduced to reduce the form factor of a mobile device and to reduce possible interference as RF signals are transported across conductors in a mobile device.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

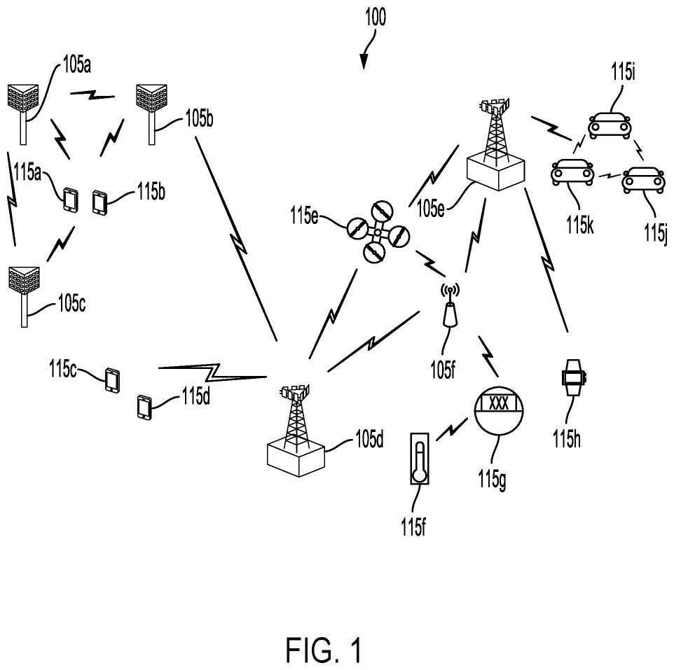

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

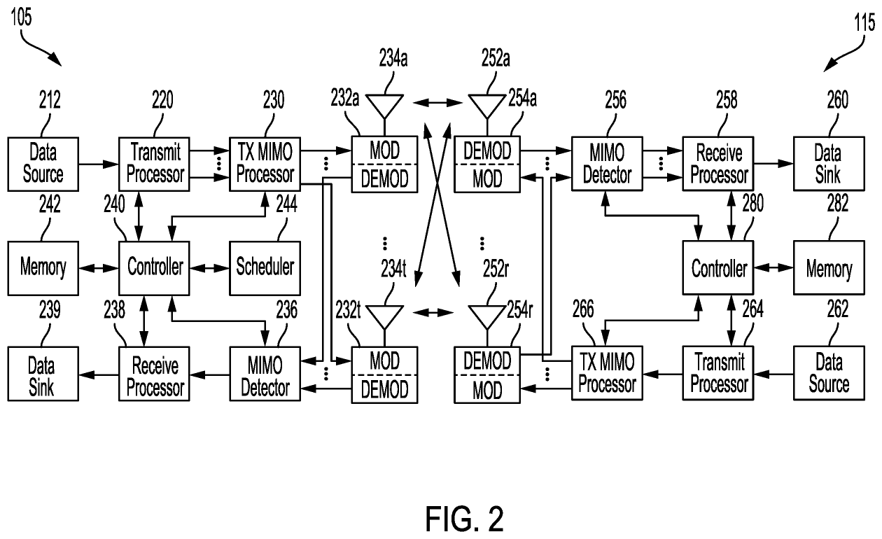

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

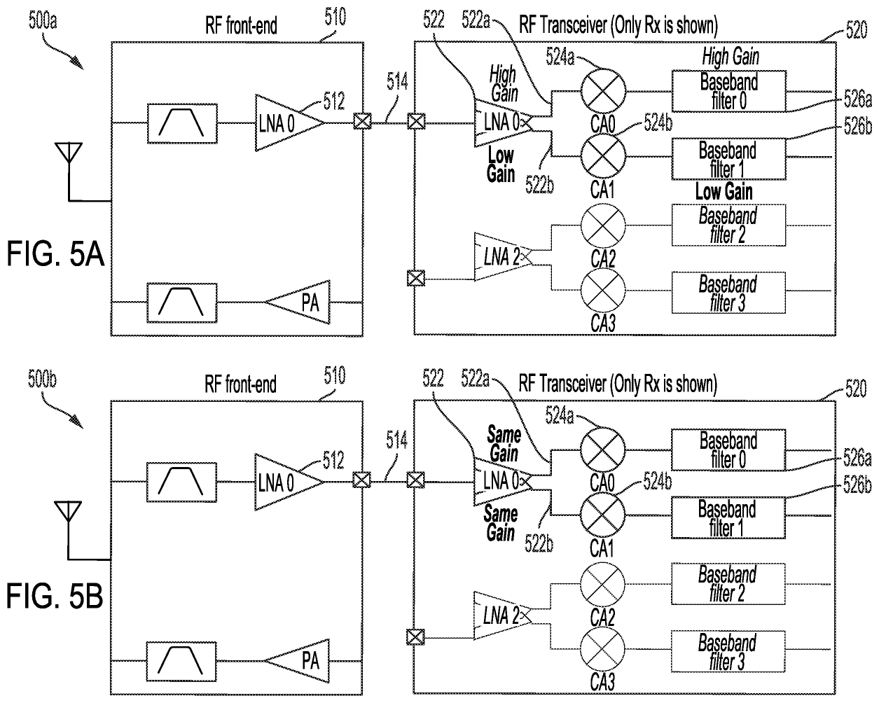

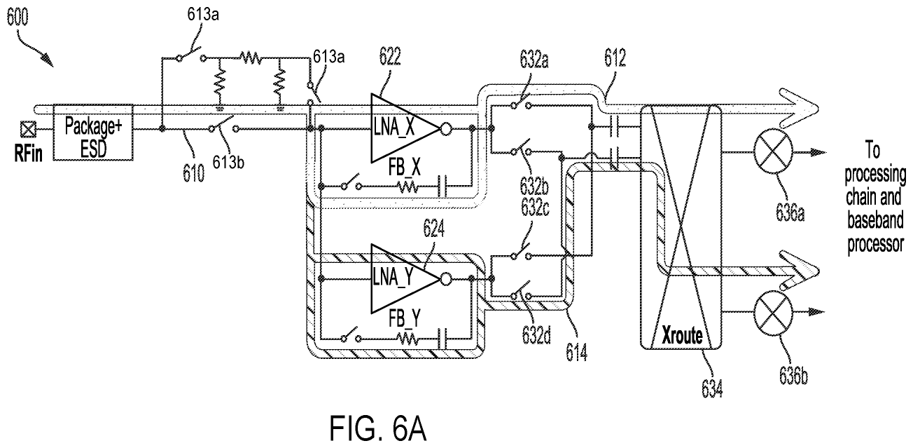

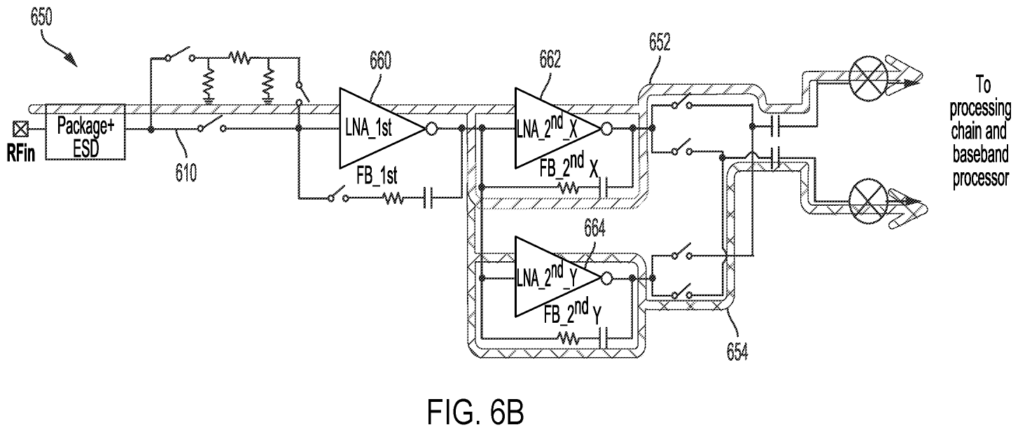

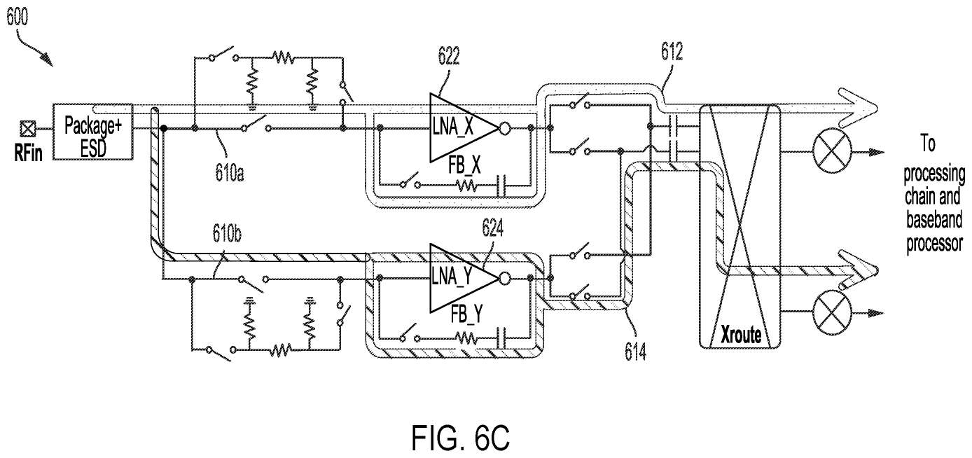

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5 or FIG. 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

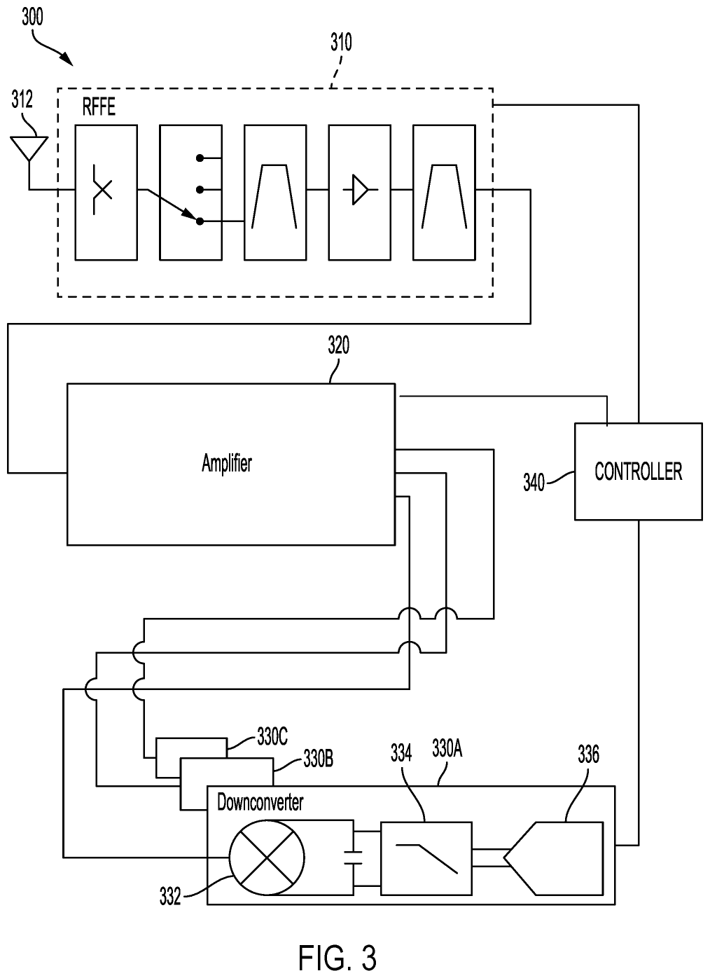

FIG. 3 is a block diagram illustrating a wireless receiver circuit 300, which may be included in a UE 115, according to one or more aspects. In some embodiments, the receiver circuit 300 may be part of a converged sub-6 Ghz and mmWave radio frequency (RF) transceiver (e.g., to process IF signals for mmW communications), a sub-6 GHz radio frequency (RF) transceiver, or a mmWave radio frequency (RF) transceiver. In some embodiments, portions or all of the receiver circuit of FIG. 3 may be located in a single integrated circuit (IC) sharing a common substrate. In other embodiments, certain of the components may be implemented in separate circuits or chips. The receiver circuit 300 may include an antenna 312 to receive radio frequency (RF) signals, such as a phase antenna array or a single antenna. The antenna 312 is coupled to a RF front-end (RFFE) 310, which may include duplexers, filters, switches, LNAs, and/or other transmit or receive circuits for conditioning signals received from the antenna 312. In some embodiments, the RFFE 310 may include separate circuits for conditioning or otherwise processing sub-6 GHz signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be an input RF signal to other circuitry comprising the conditioned sub-6 GHz signal and a conditioned mmWave IF signal. The RFFE 310 is coupled to an amplifier 320, such as a low noise amplifier (LNA). The amplifier 320 is coupled to one or more downconverters 330A, 330B, and 330C. Each of the downconverters 330A, 330B, and 330C may include mixers 332, baseband filters (BBFs) 334, and/or analog-to-digital converters (ADCs) 336. The downconverters 330A, 330B, 330C may include one or more harmonic rejection mixers (HRMs). In some embodiments, the amplifier 320 is shared on an IC with one or more of the RFFE 310 and/or the downconverters 330A, 330B, and 330C. For example, an RF transceiver IC may include the amplifier 320 and the downconverters 330A, 330B, and 330C along with other circuitry. In some examples, controller 340 is also included.

In some embodiments, the receiver circuit 300 may support carrier aggregation (CA) operation. Carrier aggregation (CA) involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change.

The controller 340 may detect conditions in the RF signal received from the antenna 312 or receive information regarding the carrier configuration from higher levels, such as a MAC layer or network layer. The controller 340 may configure components of the receiver circuit 300 to activate, deactivate, or control portions of the receiver circuit 300 to process an input RF signal. In some embodiments, the controller 340 may configure amplification gain in one or more processing paths of an RF transceiver coupled to the RFFE 310.

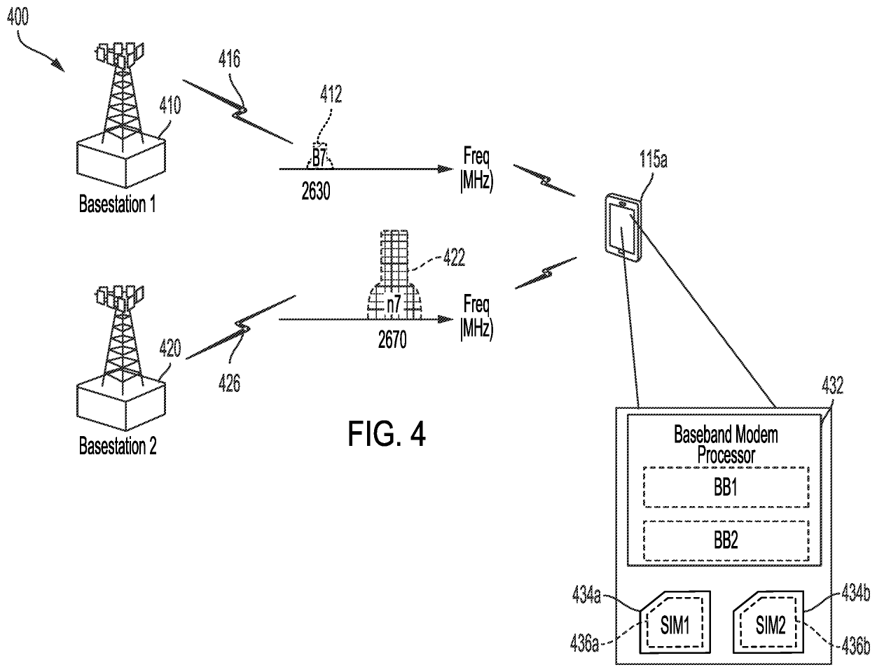

Various embodiments of this disclosure may be operated within a communication system 400, an example of which is illustrated in FIG. 4. FIG. 4 is a block diagram illustrating multiple-SIM operation according to one or more aspects. A first mobile network is operated with first base station 410, and a second mobile network is operated with a second base station 420. The first base station 410 may broadcast a first mobile network in a first serving cell. The second base station 420 may broadcast a second mobile network in a second serving cell. The first base station 410 and/or the second base station 420 may be an example of a base station 105. A UE 115a may acquire cell service from the first serving cell and/or the second serving cell.

The UE 115a may be in communication with the first mobile network of the first base station 410 through a first cellular connection 416 on carrier signal 412 (e.g., band B7 of a LTE network). The first cellular connection 416 may correspond to a first subscription of the UE 115a. The UE 115a may also be in communication with the second mobile network of the second base station 420 through a second cellular connection 426 on carrier signal 422 (e.g., band n7 of a 5G NR network). The second cellular connection 426 may correspond to a second subscription of the UE 115a, as in a multi-SIM context. In some examples, both the first subscription and the second subscription may locate a same serving cell (e.g., the first serving cell), such that the UE 115a communicates in a multi-SIM context with only one of the base stations 410 and 420. In some embodiments, the UE 115a is configured according to one of the example embodiments described with respect to FIGS. 5-7 may operate as a MSMA device that can be active on both carrier signal 412 and carrier signal 422. In some embodiments, the UE 115a is configured according to one of the example embodiments described with respect to FIGS. 5-7 may operate as a MSMS device that can be active on one of the carrier signals 412, 422 while idle on the other of the carrier signals 412, 422.

The first cellular connection 416 and the second cellular connection 426 may be made through two-way wireless communication links. Each of the wireless communication links 416 and 426 may include operation according to FDMA, TDMA, CDMA, UMTS (particularly, WCDMA, LTE, 5G, and the like), GSM, GPRS, Wi-Fi, PCS, or another protocol used in a wireless communications network or a data communications network. By way of illustrating with a non-limiting example, the first cellular connection 416 and the second cellular connection 426 may each be a 5G subscription. In some embodiments, the first cellular connection 416 and the second cellular connection 426 may each be associated with a different RAT. In other embodiments, the first cellular connection 416 and the second cellular connection 426 may be associated with a same RAT.

Each of the first base station 410 and the second base station 420 may include at least one antenna group or transmission station located in the same or different areas. The at least one antenna group or transmission station may be associated with signal transmission and reception. Each of the first base station 410 and the second base station 420 may include one or more processors, modulators, multiplexers, demodulators, demultiplexers, antennas, and the like for performing the functions described herein. In some embodiments, the first base station 410 and the second base station 420 may be an access point, Node B, evolved Node B (eNode B or eNB), base transceiver station (BTS), or the like.

In various embodiments, the UE 115a may be configured to access the first mobile network by use of the multi-SIM and/or the multi-mode SIM configuration of the UE 115a (e.g., via the first cellular connection 416 and the second cellular connection 426). When a SIM corresponding to a subscription is received, the UE 115a may access the mobile communication network associated with that subscription based on the information stored on the SIM. While the UE 115a is shown connected to the mobile network through two cellular connections 416 and 426, in some embodiments the UE 115a may establish additional cellular connections associated with additional subscriptions in a manner similar to those described above.

The UE 115a may include a first SIM interface 434a, which may receive a first identity module SIM-1 436a that is associated with the first subscription. The UE 115a may also include a second SIM interface 434b, which may receive a second identity module SIM-2 436b that is associated with the second subscription. In some embodiments, the first subscription may be different from the second subscription. In other embodiments, the first subscription may be a same subscription as the second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 115a, and thus need not be a separate or removable circuit, chip, or card, such as with an electronic SIM (eSIM). A SIM as used in embodiments described herein includes physical SIMs, embedded SIMs, and electronic SIMs.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

Each SIM in the UE 115a (e.g., the SIM-1 436a and the SIM-2 436b) may be associated with a baseband-RF resource chain. A baseband-RF resource chain may include the baseband modem processor 432, which may perform baseband/modem functions for communications on at least one SIM, and may include one or more amplifiers and downconverters, referred to generally herein as RF resources, such as described with reference to FIG. 3 and embodiments of a RF transceiver as described in FIGS. 5A, 5B, 6A, 6B, and 6C. In some embodiments, baseband-RF resource chains may share the baseband modem processor 432 in which a single device performs baseband/modem functions for all SIMs on the UE 115a (e.g., for baseband 1 (BB1) functions and/or signals corresponding to the first carrier signal 412 and for baseband 2 (BB2) functions and/or signals corresponding to the second carrier signal 422). In other embodiments, each baseband-RF resource chain may include physically or logically separate baseband processors.

The UE 115a may include RF resources for processing RF signals received at an antenna of the UE 115, and those RF resources coupled to the baseband modem processor 432. Example configurations of those RF resources for processing RF signals with a split LNA with different gains for MSIM operation are shown in FIGS. 5A, 5B, 6A, 6B, and 6C. FIG. 5A is a block diagram illustrating an RF processing circuit with a split LNA for MSIM operation according to one or more aspects. A circuit 500a includes a RF front end (RFFE) 510 coupled to a RF transceiver 520 through a conductor 514. The RF transceiver 520 may be a single semiconductor die with at least the elements 522, 524a, and 524b constructed on the same single semiconductor die. The conductor 514 may be, for example, a trace, a transmission line, a cable, or another structure for conveying the RF signal between the RFFE 510 and the RF transceiver 520. In some embodiments, a RF signal path from the antenna to the RF transceiver is through a single conductor, such as conductor 514, without splitting into multiple signal paths before passing from RFFE 510 to RF transceiver 520. Although a single conductor is described, the single conductor from RFE 510 to RF transceiver 520 includes other communication techniques for transmitting a single signal path through multiple conductors such as differential signaling. The reduced number of conductors between the RFFE 510 and the RF transceiver 520 provides benefits such as reduced complexity and reduced interference. In other embodiments, the output of LNA 512 may be selectively coupled to LNA2 in the RF transceiver 520. In some embodiments, LNA2 may be coupled to other RFFE components or may be omitted (as may the downstream components illustrated as being coupled to LNA2). In configurations in which LNA2 may be coupled to the LNA 512, LNA2 may in some examples be configured similar to LNA 522 and downstream components coupled to LNA2 may be configured similar to downstream components coupled to LNA 522. In some embodiments, the elements of the RF transceiver 520 are implemented in a single IC or chip.

The RF transceiver 520 includes a split LNA 522 with a first output 522a and a second output 522b. The amplifier gain of the first output 522a and the second output 522b may be differently adjusted within the split LNA 522. The separate gains allow the split LNA 522 to process RF signals in which carriers in the RF signals have differing signal power levels. For example, with reference to the network of FIG. 4, a low power signal received from first base station 410 may be processed by the split LNA 522 with a higher gain for output to first output 522a and a higher power signal received from the second base station 420 may be processed by the split LNA 522 with a lower gain for output to second output 522b.

The outputs 522a, 522b may be coupled to different RF processing chains for processing of the amplified RF signal. For example, the first output 522a may be coupled to mixer 524a and baseband filter (BBF) 526a. The second output 522b may likewise be coupled to mixer 524b and baseband filter (BBF) 526b. The first output 522a and second output 522b may be coupled to a first output port and a second output of LNA 522, respectively. The LNA 522 provides output to two output ports by splitting a single input signal from the RFFE 5510. The split for multi-SIM operation thus occurs within the RF transceiver 520 semiconductor die in some embodiments. In some embodiments, gain of the BBFs 526a and 526b may be differently adjusted to provide different processing of different carrier signals in addition to or in alternative to the different gains of the split LNAs 522. Although two symmetric RF processing chains are shown for the outputs 522a and 522b, the outputs may be coupled to asymmetric RF processing chains.

When the UE is not operating with a MSIM configuration, the UE may reconfigure circuit 500a to circuit 500b. In circuit 500b, the split LNA 522 may be controlled to have approximately the same amplification gain at each of the outputs 522a and 522b. The approximately same amplification gain may result in signals at each of outputs 522a, 522b that are within a certain threshold amount (e.g., 6 dB) of each other. This configuration may be used to support carrier aggregation (CA) operation, in which the carrier signals in the RF signal originate from the same base station resulting in the two RF signals having similar signal power levels. In some examples, the configuration is for intra-band CA. When switching from MSIM configuration to CA configuration, other components of the RF processing chain may likewise be reconfigured, such as changing a local oscillator (LO) signal proceeded to mixers 524a and 524b to correspond to the carriers active in the UE's CA configuration.

Example circuits for split LNAs are shown in FIGS. 6A, 6B, and 6C. FIG. 6A is a split LNA circuit with adjustable output gains based on slices, bias control, feedback resistance, and/or attenuator according to one or more aspects. A circuit 600 includes a first LNA 622 and a second LNA 624 coupled to receive the same RF signal (e.g., coupled to a common input), which may pass through input attenuator circuit 610. The attenuator circuit 610 may include one or more resistors that may be configured, through one or more switches, to couple into the signal path for the received RF signal or to couple out of the signal path. In some configurations, the attenuator circuit 610 includes one or more resistors coupled in shunt, e.g., in a pi configuration. For example, when the switches 613a are closed and the switch 613b is open, the RF signal passes through a resistor coupled on either side to respective shunt resistors to attenuate (e.g., reduce the signal strength of) the RF signal. Alternatively, when the switches 613a are open and the switch 613b is closed, the RF signal bypasses the attenuator.

A first signal path 612 through the circuit 600 is amplified by the LNA 622 and output to a first mixer for downconversion and output to further components for processing of the downconverted signal (e.g., a baseband BB processor when the output of mixers 636a, 636b are baseband signals). A second signal path 614 through the circuit 600 is amplified by the LNA 624 and output to a second mixer for downconversion and output to further components in an RF processing chain. The gains of LNAs 622 and 624 may be differently controlled, for example, by adjusting a number of active slices within each of the LNAs 622 and 624. In some embodiments, the LNAs 622 and 624 may each have multiple (e.g., eight) slices, and more slices may be activated to increase amplification gain and fewer slices may be activated to decrease amplification gain.

Additionally or alternatively, the gain may be adjusted by differently adjusting feedback resistance elements FB_X and FB_Y corresponding to LNAs 622 and 624, respectively. In addition to the gain adjustment, the feedback resistance elements FB_X and FB_Y may also control input impedance matching and linearity performance of the LNAs 622 and 624. For example, the total resistance of FB_X and FB_Y may determine the input impedance of the LNAs 622 and 624 with the open-loop gains of the LNAs 622 and 624, and the linearity of LNAs 622 and 624 may be adjusted by the individual value of FB_X and FB_Y, respectively. The values of FB_X and FB_Y may be chosen based on considering input impedance matching, linearity, as well as gain factors during operation of the circuit 600. For example, the values of variable resistors FB_X and FB_Y may be increased or decreased to adjust the gain at the output of the LNAs 622 and 624, respectively.

Additionally or alternatively, the gain may be adjusted by differently adjusting bias control for LNAs 622 and 624. For example, adjusting an active bias voltage to the transistors of the LNAs 622 or 624 can change the amplification amount of the LNAs 622 or 624. Multiple bias generation circuits may be included in the RF transceiver 520 to supply different biases to LNAs 622 and 624. As described above, additional gain adjustment may be performed by a downstream BBF. The outputs of the LNAs 622 and 624 may pass through switches 632a-d and cross-routing 634 to couple to one of the mixers 636a-b. For example, LNA 622 may couple to mixer 636a and LNA 624 to mixer 636b when switches 632a and 632d are closed while switches 632b and 634c are open.

Another example split LNA configuration may include multiple stages of amplification. FIG. 6B is a split LNA circuit with adjustable output gains based on multiple amplification stages according to one or more aspects. A circuit 650 includes a first stage LNA 660 with feedback resistor FB_1^{st} and two second stage LNAs 662 and 664 with feedback resistors FB_2ndX, FB_2ndY, respectively. The second stage LNAs 662 and 664 receive an RF signal from a common first stage LNA 660, which receives an RF signal from a RF front end through attenuation circuit 610. The second stage LNAs 662 and 664 may have gain controlled through adjusting number of active slices, adjusting a bias, adjusting a feedback resistance element, or the like. Separate gain control for MSIM operation may thus be achieved in the second-stage LNAs. As described above, additional gain adjustment may be performed by a downstream BBF. In some configurations, signals are processed concurrently through the LNAs 662, 664 during MSIM operation. In other configurations, signals are processed at different times by the LNAs 662, 664 during MSIM operation. In some examples, each of the LNAs 662, 664 may be selectively enabled and disabled. In some examples, the LNAs 662, 664 have a different number of slices and/or a different gain range. For example, the LNA 662 may be configured to provide a higher range of gains than the LNA 664 with an overlapping portion in the middle of the two ranges which both LNA 662 and 664 can provide.

Another example split LNA configuration may include adjustable input attenuators. FIG. 6C is a split LNA circuit with individual attenuators 610a, 610b for each LNA to provide gain control according to one or more aspects of the disclosure. Each LNA 622 and 624 may have separate input attenuators, and the attenuation of the input attenuators differently controlled to produce different amplification gains for signal paths 612 and 614 in addition to adjusting their slices, bias controls, and feedback resistances. The attenuators for each LNA 622 and 624 may be controlled to provide steps of attenuation that reduce the output gain for a corresponding LNA 622 or 624. For example, an attenuator may provide a maximum of −18 dB attenuation in 3 dB steps. The total output gain of the LNAs 622 and 624 may be a combination of attenuation from the attenuator, gain from the slices and bias control.

As described above, additional gain adjustment may be performed by a downstream BBF. In some configurations, signals are processed concurrently through the LNAs 622, 624 in FIG. 6A and/or 6C during MSIM operation. In other configurations, signals are processed at different times by the LNAs 622, 624 during MSIM operation. In some examples, each of the LNAs 662, 664 may be selectively enabled and disabled. In some examples, the LNAs 622, 624 have a different number of slices and/or a different gain range in FIG. 6A and/or 6C. For example, the LNA 622 may be configured to provide a higher range of gains than the LNA 624 with an overlapping portion in the middle of the two ranges which both LNA 622 and 624 can provide.

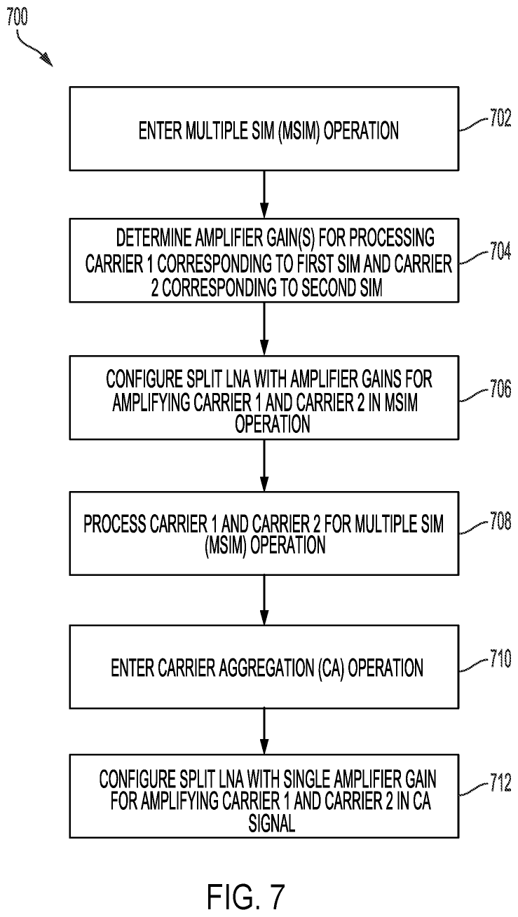

A method for operating a RF transceiver by controlling adjustable gains applied to different carrier signals of an RF signal is shown in FIG. 7. The method 700 may be performed, for example with reference to FIG. 3, by a controller 340 to adjust configuration of amplifiers 320, which may be one or more of the LNAs configured as shown in FIGS. 5A, 5B, 6A, 6B, and 6C. The amplifier 320 and downconverters 330A, 330B, and 330C may comprise a RF transceiver coupled to the RFFE 310. The controller 340 may be integrated as part of the RF transceiver or a circuit outside the RF transceiver, such as a separate applications processor or a baseband modem processor (e.g., 432) coupled to the RF transceiver.

The method 700 may include, at block 702, entering multiple SIM (MSIM) operation. MSIM operation may be configured by the controller, for example, based on a user configuring a connection using a second SIM on the UE. MSIM operation may alternatively or additionally be configured by the controller, for example, based on receiving an instruction from the BS.

At block 704, amplifier gains may be determined for processing a first carrier (carrier 1) corresponding to a first network connection based on a first subscriber identity module (SIM) and processing a second carrier (carrier 2) corresponding to a second network connection based on a second SIM. The two or more amplifier gains may be configured based on, for example, the controller receiving feedback from the RFFE or other component indicating signal power levels of different carrier signals received through the antenna. The amplifier gains may additionally or alternatively be configured based on, for example, the controller retrieving information about a location of the BS for each carrier signal, environmental conditions within a cell corresponding to each carrier signal, or other information.

At block 706, a split LNA is configured to provide the determined amplifier gains of block 704 for amplifying the two carrier signals during MSIM operation. The controller may provide a configuration signal to the RF transceiver to set the amplifier gains at the output of the split LNA. For example, the controller may send a control signal to adjust a feedback element, send a control signal to activate one or more slices of the split LNAs, or send control information to a controller local to the split LNA, which then generates control signals to apply the determined amplifier gain. In some embodiments in which the split LNA includes adjustable slices, the controller may generate a plurality of enable signals supplied to each of the slices of the split LNA.

At block 708, the carrier signals are processed for MSIM operation. For example, first and second amplified RF signals may be processed by downconversion to first and second baseband signal that are further processed to determine user data and/or control information.

The operating mode may change during operation of the user equipment. For example, the UE may be configured for carrier aggregation (CA) operation, which may provide higher data throughput by employing two carriers for transmission of data between a single UE and BS. The amplifier configurations of FIGS. 5A, 5B, 6A, 6B, and 6C may likewise support CA operation by appropriately adjusting the amplification gains within the split LNA.

At block 710, the UE may enter carrier aggregation (CA) operation. CA operation may be configured by the controller, for example, based on receiving an instruction from the BS. The instruction may be, for example, a resource allocation by the BS that includes resources spread across multiple carriers, including inter-band CA and intra-band CA.

At block 712, the split LNA is configured with the same amplification gain for the first carrier and the second carrier received by the UE from the BS during CA operation. In some embodiments, CA operation may include applying different gains during CA operation to the first and second carriers, such as when the carriers are at different frequencies that have different propagation and interference characteristics.

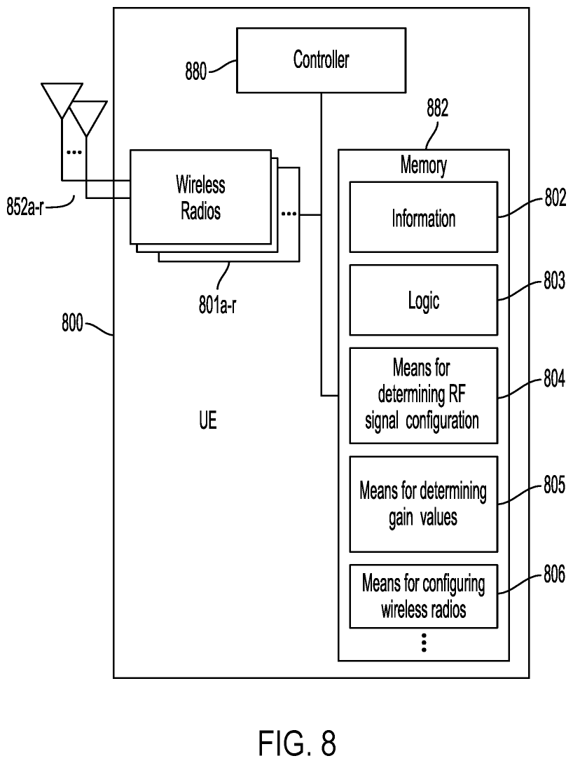

Operations of method 700 may be performed by a UE, such as UE 115 described above with reference to FIG. 1 or FIG. 2, or a UE described with reference to FIG. 8. For example, example operations (also referred to as “blocks”) of method 700 may enable UE 115 to support MSIM operation.

FIG. 8 is a block diagram of an example UE 800 that supports reconfiguring a RF transceiver of a wireless radio according to one or more aspects of the disclosure. UE 800 may be configured to perform operations, including the blocks of a process described with reference to the above methods. In some implementations, UE 800 includes the structure, hardware, and components shown and described with reference to UE 115 of FIG. 1 or FIG. 2. For example, UE 800 includes controller 880, which operates to execute logic or computer instructions stored in memory 882, as well as controlling the components of UE 800 that provide the features and functionality of UE 800. UE 800, under control of controller 880, transmits and receives signals via wireless radios 801a-r and antennas 852a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266. Wireless radios 801a-r may also include one or more receiver circuits with downconverters configured as shown in FIG. 5A, 5B, 6A, 6B, or 6C.

As shown, memory 882 may include information 802, logic 803, means for determining RF configuration 804, means for determining amplifier gain values 805, and/or means for configuring wireless radios 806. Information 802 may be configured to include, for example, component values for corresponding sets of active frequencies and/or carrier aggregation sets. Logic 803 may be configured to process the information 802, update the information 802, generate new configuration data for information 802, and/or store information regarding the current operating mode, e.g., assigned DL grants and/or BWPs. Means for determining RF signal configuration 804 may be configured to receive information from the wireless radios 801a-r, from the controller 880, and/or from information 802 to determine active frequencies in a signal received by the UE 800. Means for determining amplifier gain values 805 may be configured to determine gains for separate outputs of the split LNA based on the determined wireless radio configuration from block 804. For example, block 805 may obtain appropriate information from a lookup table stored in information 802 using the configuration determined by block 805 as an index into the look-up table. Means for configuring wireless radios 806 may use the values determined by block 805 to change the configuration of one or more of the wireless radios 801a-r, such as through the controller 880. In some embodiments, some of the wireless radios 801a-r may be configured for mmWave operation and other of the wireless radios 801a-r may be configured for sub-6 GHz operation.

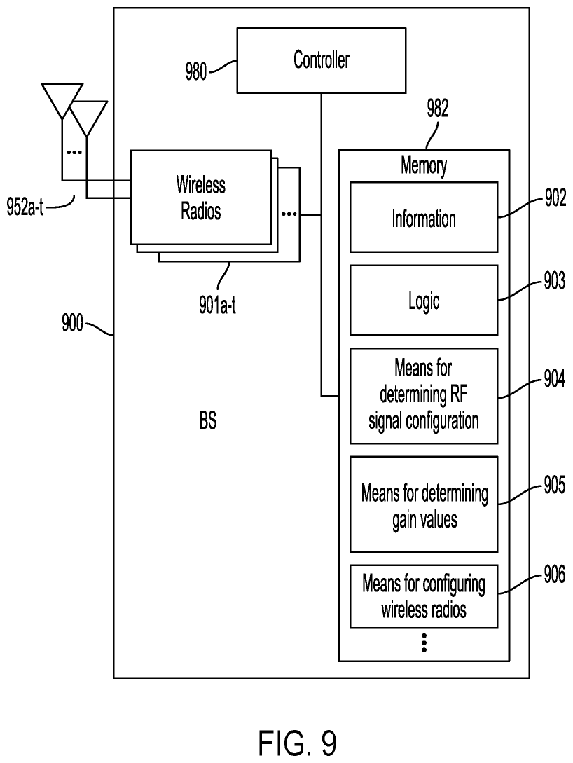

UE 800 may receive signals from or transmit signals to one or more network entities, such as base station 105 of FIG. 1 or FIG. 2 or a base station as illustrated in FIG. 9. FIG. 9 is a block diagram of an example base station 900 that supports reconfiguring a RF transceiver of a wireless radio according to one or more aspects of the disclosure. Base station 900 may be configured to perform operations, including the blocks of method 700 described with reference to FIG. 7. In some implementations, base station 900 includes the structure, hardware, and components shown and described with reference to base station 105 of FIG. 1 or FIG. 2. For example, base station 900 may include controller 240, which operates to execute logic or computer instructions stored in memory 242, as well as controlling the components of base station 900 that provide the features and functionality of base station 900. Base station 900, under control of controller 240, transmits and receives signals via wireless radios 901a-t and antennas 934a-t. Wireless radios 901a-t include various components and hardware, as illustrated in FIG. 2 for base station 105, including modulator and demodulators 232a-t, transmit processor 220, TX MIMO processor 230, MIMO detector 236, and receive processor 238. Wireless radios 901a-t may also include one or more receiver circuits with downconverters configured as shown in FIG. 5A, 5B, 6A, 6B, or 6C.

As shown, memory 982 may include information 902, logic 903, means for determining carrier aggregation configuration 904, means for determining amplifier gain values 905, and/or means for configuring wireless radios 906. Information 902 may be configured to include, for example, component values for corresponding sets of active frequencies and/or carrier aggregation sets. Logic 903 may be configured to process the information 902, update the information 902, generate new configuration data for information 902, and/or store information regarding the current operating mode, e.g., assigned DL grants and/or BWPs. Means for determining RF signal configuration 904 may be configured to receive information from the wireless radios 901a-t, from the controller 980, and/or from information 902 to determine a configuration of carriers and SIMs the BS 900. Means for configuring wireless radios 906 may use the values determined by block 905 to change the configuration of one or more of the wireless radios 901a-t, such as through the controller 980 to adjust an amplifier gain at outputs of a split LNA within an RF transceiver of one or more of the wireless radios 901a-t. In some embodiments, some of the wireless radios 901a-t may be configured for mmWave operation and other of the wireless radios 901a-t may be configured for sub-6 GHz operation. Base station 900 may receive signals from or transmit signals to one or more UEs, such as UE 115 of FIG. 1 or FIG. 2 or UE 800 of FIG. 8.

In one or more aspects, techniques for supporting wireless communications, such as on multiple frequency bands, may include additional aspects, such as any single aspect or any combination of aspects described below or in connection with one or more other processes or devices described elsewhere herein. In a first aspect, supporting wireless communication may include an apparatus with a RF transceiver with a split LNA configurable with different amplifier gains at different outputs. Additionally, the apparatus may perform or operate according to one or more aspects as described below. In some implementations, the apparatus includes a wireless device, such as a UE or a base station (BS). In some implementations, the apparatus may include at least one processor, and a memory coupled to the processor. The processor may be configured to perform operations described herein with respect to the apparatus, including operations described herein with respect to methods of operating a wireless device. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a first aspect, supporting wireless communication may include an apparatus configured to support multiple SIM (MSIM) operation by including an input port for receiving a radio frequency (RF) signal comprising a first carrier corresponding to a first subscriber identity module (SIM) and a second carrier corresponding to a second subscriber identity module (SIM); a split low noise amplifier (LNA) coupled to the input port and a first output port and a second output port, the split LNA configured to output the RF signal with a first gain as a first amplified RF signal at the first output port and to output the RF signal with a different, second gain as a second amplified RF signal at the second output port; a first RF processing chain coupled to the first output port for processing the first carrier; and a second RF processing chain coupled to the second output port for processing the second carrier.

In a second aspect, in combination with the first aspect, the split LNA comprises a plurality of slices, and the apparatus further includes a controller configured to control the split LNA to provide the first output port with the first gain and the second output port with the second gain by controlling the plurality of slices.

In a third aspect, in combination with one or more of the first aspect or the second aspect, the split LNA comprises a plurality of bias controls, and the apparatus further includes a controller configured to control the split LNA to provide the first output port with the first gain and the second output port with the second gain by controlling the plurality of bias controls.

In a fourth aspect, in combination with one or more of the first aspect through the third aspect, the split LNA comprises a plurality of attenuators, and the apparatus further includes a controller configured to control the split LNA to provide the first output port with the first gain and the second output port with the second gain by controlling the plurality of attenuators.

In a fifth aspect, in combination with one or more of the first aspect through the fourth aspect, the split LNA comprises a plurality of stages of amplifiers, and the apparatus further includes a controller configured to control the split LNA to provide the first output port with the first gain and the second output port with the second gain by controlling the plurality of stages of amplifiers.

In a sixth aspect, in combination with one or more of the first aspect through the fifth aspect, the first RF processing chain comprises a first baseband filter configured to provide a third gain to the first amplified RF signal, and the second RF processing chain comprises a second baseband filter to provide a fourth gain to the second amplified RF signal.

In a seventh aspect, in combination with one or more of the first aspect through the sixth aspect, the input port is coupled to a RF front end (RFFE) for receiving the RF signal comprising the first carrier and the second carrier through a single conductor.

In an eighth aspect, in combination with one or more of the first aspect through the seventh aspect, a RF transceiver comprises the split LNA, the first RF processing chain, and the second RF processing chain.

In a ninth aspect, in combination with one or more of the first aspect through the eighth aspect, the apparatus further includes a first SIM interface for receiving a first SIM; a second SIM interface for receiving a second SIM; and a baseband modem processor coupled to the first RF processing chain and to the second RF processing chain and coupled to the first SIM interface and to the second SIM interface, the baseband modem processor configured to process the first amplified RF signal based on the first SIM and to process the second amplified RF signal based on the second SIM.

In a tenth aspect, in combination with one or more of the first aspect through the ninth aspect, the input port is coupled to receive the RF signal from an antenna through a single low noise amplifier (LNA) in the RFFE.

In an eleventh aspect, in combination with one or more of the first aspect through the tenth aspect, the apparatus further includes a controller coupled to the split LNA and configured to adjust the first gain and the second gain, wherein the controller is configured to control the first gain with the second gain when the RF signal is a carrier aggregation (CA) signal associated with the first SIM and to control the first gain differently from the second gain when the RF signal is a multi-SIM (MSIM) signal.

In a twelfth aspect, in combination with one or more of the first aspect through the eleventh aspect, a method for wireless communication may include determining a multiple subscriber identity module (MSIM) operating configuration for processing a first carrier signal and a second carrier signal of an RF signal; determining a first amplifier gain for the first carrier signal of the MSIM operating configuration; determining a different, second amplifier gain for the second carrier signal of the MSIM operating configuration; and configuring a RF transceiver comprising a split LNA with a first output and a second output with the first amplifier gain for the first output and the second amplifier gain for the second output.

In a thirteenth aspect, in combination with one or more of the first aspect through the twelfth aspect, configuring the RF transceiver comprises configuring a plurality of attenuators of the RF transceiver.

In a fourteenth aspect, in combination with one or more of the first aspect through the thirteenth aspect, configuring the RF transceiver comprises configuring a plurality of stages of amplifiers of the RF transceiver.

In a fifteenth aspect, in combination with one or more of the first aspect through the fourteenth aspect, configuring the RF transceiver comprises configuring a plurality of slices of the split LNA.

In a sixteenth aspect, in combination with one or more of the first aspect through the fifteenth aspect, configuring the RF transceiver comprises configuring a plurality of bias controls to the split LNA.

In a seventeenth aspect, in combination with one or more of the first aspect through the sixteenth aspect, configuring the RF transceiver comprises configuring a first baseband filter of the RF transceiver with a third gain determined for the first carrier signal and configuring a second baseband filter of the RF transceiver with a fourth gain determined for the second carrier signal.

In an eighteenth aspect, in combination with one or more of the first aspect through the seventeenth aspect, determining the first amplifier gain and determining the second amplifier gain is based on feedback from a radio frequency front end (RFFE) coupled to the RF transceiver.

In a nineteenth aspect, in combination with one or more of the first aspect through the eighteenth aspect, the method may also include processing the first output of the split LNA with a baseband modem processor based on a first subscriber identify module (SIM); and processing the second output of the split LNA with the baseband modem processor based on a second subscriber identity module (SIM).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 1. As another example, one or more blocks associated with FIG. 4 may be combined with one or more blocks (or operations) associated with FIG. 1. Additionally, or alternatively, one or more operations described above with reference to FIGS. 1-4 may be combined with one or more operations described with reference to FIGS. 5-9.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a radio frequency (RF) transceiver comprising a semiconductor die, the RF transceiver comprising:
an input port for receiving a radio frequency (RF) signal comprising a first carrier corresponding to a first subscriber identity module (SIM) and a second carrier corresponding to a second subscriber identity module (SIM); and
a low noise amplifier (LNA) coupled to the input port and a first output port and a second output port, the LNA configured to output the RF signal with a first gain as a first amplified RF signal at the first output port and to output the RF signal with a different, second gain as a second amplified RF signal at the second output port.

2. The apparatus of claim 1, wherein:
the LNA comprises a plurality of slices, and
the apparatus further comprises:
a controller configured to control the LNA to provide the first output port with the first gain and the second output port with the second gain by controlling the plurality of slices.

3. The apparatus of claim 1, further comprising:
a controller configured to control the LNA to provide the first output port with the first gain and the second output port with the second gain by supplying a different bias to different parts of the LNA corresponding to the first output port and the second output port.

4. The apparatus of claim 1, wherein:
the LNA comprises a plurality of attenuators, and
the apparatus further comprises:
a controller configured to control the LNA to provide the first output port with the first gain and the second output port with the second gain by controlling the plurality of attenuators.

5. The apparatus of claim 1, wherein:
the LNA comprises a plurality of stages of amplifiers, and
the apparatus further comprises:
a controller configured to control the LNA to provide the first output port with the first gain and the second output port with the second gain by controlling the plurality of stages of amplifiers.

6. The apparatus of claim 1, further comprising:
a first RF processing chain coupled to the first output port for processing the first carrier, the first RF processing chain comprising a first baseband filter configured to provide a third gain to the first amplified RF signal; and
a second RF processing chain coupled to the second output port for processing the second carrier, the second RF processing chain comprising a second baseband filter to provide a fourth gain to the second amplified RF signal.

7. The apparatus of claim 6, wherein the input port is coupled to a RF front end (RFFE) for receiving the RF signal comprising the first carrier and the second carrier through a single signal path.

8. The apparatus of claim 7, wherein:
a RF transceiver comprises the LNA, the first RF processing chain, and the second RF processing chain, and
the apparatus further comprising:
a first SIM interface for receiving a first SIM;
a second SIM interface for receiving a second SIM; and
a baseband modem processor coupled to the first RF processing chain and to the second RF processing chain and coupled to the first SIM interface and to the second SIM interface, the baseband modem processor configured to process the first amplified RF signal based on the first SIM and to process the second amplified RF signal based on the second SIM.

9. The apparatus of claim 7, wherein the input port is coupled to receive the RF signal from an antenna through a single low noise amplifier (LNA) in the RFFE.

10. The apparatus of claim 8, further comprising:
a controller coupled to the LNA and configured to adjust the first gain and the second gain, wherein the controller is configured to:
control the first gain with the second gain when the RF signal is a carrier aggregation (CA) signal associated with the first SIM; and
control the first gain differently from the second gain when the RF signal is a multi-SIM (MSIM) signal.

11. A method, comprising:
determining a multiple subscriber identity module (MSIM) operating configuration for processing a first carrier signal and a second carrier signal of an RF signal;
determining a first amplifier gain for the first carrier signal of the MSIM operating configuration;
determining a different, second amplifier gain for the second carrier signal of the MSIM operating configuration; and
configuring a RF transceiver comprising a LNA with a first output and a second output with the first amplifier gain for the first output and the second amplifier gain for the second output.

12. The method of claim 11, wherein configuring the RF transceiver comprises configuring a plurality of attenuators of the RF transceiver.

13. The method of claim 11, wherein configuring the RF transceiver comprises configuring a plurality of stages of amplifiers of the RF transceiver.

14. The method of claim 11, wherein configuring the RF transceiver comprises configuring a plurality of slices of the LNA.

15. The method of claim 11, wherein configuring the RF transceiver comprises configuring a plurality of bias controls to the LNA.

16. The method of claim 11, wherein configuring the RF transceiver comprises configuring a first baseband filter of the RF transceiver with a third gain determined for the first carrier signal and configuring a second baseband filter of the RF transceiver with a fourth gain determined for the second carrier signal.

17. The method of claim 11, wherein determining the first amplifier gain and determining the second amplifier gain is based on feedback from a radio frequency front end (RFFE) coupled to the RF transceiver.

18. The method of claim 11, further comprising:
processing the first output of the LNA with a baseband modem processor based on a first subscriber identify module (SIM); and
processing the second output of the LNA with the baseband modem processor based on a second subscriber identity module (SIM).

19. The method of claim 11, further comprising:
determining a carrier aggregation (CA) operating configuration for processing a third carrier signal and a fourth carrier signal of a second RF signal;
determining a third amplifier gain for the CA operating configuration; and
configuring the LNA of the RF transceiver with the first output and the second output based on the third amplifier gain.

20. An apparatus, comprising:
a memory storing processor-readable code; and
at least one processor coupled to the memory, the at least one processor configured to execute the processor-readable code to cause the at least one processor to perform operations including:
determining a multiple subscriber identity module (MSIM) operating configuration for processing a first carrier signal and a second carrier signal of an RF signal;
determining a first amplifier gain for the first carrier signal of the MSIM operating configuration;
determining a different, second amplifier gain for the second carrier signal of the MSIM operating configuration; and
configuring a RF transceiver comprising a LNA with a first output and a second output with the first amplifier gain for the first output and the second amplifier gain for the second output.

21. The apparatus of claim 20, wherein configuring the RF transceiver comprises configuring a plurality of attenuators of the RF transceiver.

22. The apparatus of claim 20, wherein configuring the RF transceiver comprises configuring a plurality of stages of amplifiers of the RF transceiver.

23. The apparatus of claim 20, wherein configuring the RF transceiver comprises configuring a plurality of slices of the LNA.

24. The apparatus of claim 20, wherein configuring the RF transceiver comprises configuring a plurality of bias controls to the LNA.

25. The apparatus of claim 20, wherein configuring the RF transceiver comprises configuring a first baseband filter of the RF transceiver with a third gain determined for the first carrier signal and configuring a second baseband filter of the RF transceiver with a fourth gain determined for the second carrier signal.

26. The apparatus of claim 20, wherein the at least one processor is further configured to perform operations including:
processing the first output of the LNA with a baseband modem processor based on a first subscriber identify module (SIM); and
processing the second output of the LNA with the baseband modem processor based on a second subscriber identity module (SIM).

27. The apparatus of claim 20, wherein the at least one processor is further configured to perform operations including:
determining a carrier aggregation (CA) operating configuration for processing a third carrier signal and a fourth carrier signal of a second RF signal;
determining a third amplifier gain for the CA operating configuration; and
configuring the LNA of the RF transceiver with the first output and the second output based on the third amplifier gain.

28. An apparatus, comprising:
a radio frequency front end (RFFE), comprising:
an antenna input port for receiving an input radio frequency (RF) signal comprising a first carrier signal and a second carrier signal; and
an output port for outputting an RF signal based on the input RF signal;
a radio frequency (RF) transceiver coupled to receive the RF signal through a first signal path, the RF transceiver comprising:
a low noise amplifier (LNA) configured to split the RF signal in the RF transceiver for output to a first output port and a second output port with a first gain and a different, second gain, respectively; and
a processor coupled to the first output port and the second output port to process signals based on a first subscriber identity module (SIM) and a second subscriber identity module (SIM) for multiple-SIM operation on the first carrier signal and the second carrier signal based on the LNA splitting the RF signal.

29. The apparatus of claim 28, further comprising a controller configured to perform operations including:
determining a multiple subscriber identity module (MSIM) operating configuration for processing a first carrier signal and a second carrier signal of the RF signal;
determining a first amplifier gain for the first carrier signal of the MSIM operating configuration;
determining a different, second amplifier gain for the second carrier signal of the MSIM operating configuration; and
configuring the LNA with the first amplifier gain for the first output port and the second amplifier gain for the second output port.

30. The apparatus of claim 28, further comprising a controller configured to perform operations including:
determining a carrier aggregation (CA) operating configuration for processing a third carrier signal and a fourth carrier signal of the RF signal;
determining a third amplifier gain for the CA operating configuration; and
configuring the LNA with the third amplifier gain for the first output port and the second output port.
